(19) United States
(12) Patent Application Publication
(10) Pub. No.: US 2007/0197083 A1
(43) Pub. Date: Aug. 23, 2007

(54) Modular Plugs and Outlets Having Enhanced Performance Contacts

(75) Inventors: Randy J. Below, Cheshire, CT (US); Olindo Savi, Kensington, CT (US); Maxwell K. Yip, Trumbull, CT (US); Daniel J. Mullin, Plantsville, CT (US); John A. Siemon, Woodbury, CT (US)

Correspondence Address: CANTOR COLBURN, LLP, 55 GRIFFIN ROAD SOUTH, BLOOMFIELD, CT, 06002, US

(73) Assignee: THE SIEMON COMPANY, Watertown, CT (US)

(21) Appl. No.: 11/672,674

(22) Filed: Feb. 8, 2007

Related U.S. Application Data
(60) Provisional application No. 60/771,535, filed on Feb. 8, 2006.

(51) Int. Cl. H01R 4/24

(52) U.S. Cl. 439/418; 439/676

(57) ABSTRACT

A telecommunications outlet including a contact carrier and a plurality of contacts supported on the contact carrier, the contacts corresponding to tip and ring pairs, at least one of the contacts having a characteristic to improves signal transmission performance by providing internal compensation to balance signals by controlling resistive, inductive or capacitive characteristics along the contacts.

### CROSS-REFERENCE TO RELATED APPLICATIONS

This application claims the benefit of provisional application Ser. No. 60/771,535, filed Feb. 8, 2006, the entire contents of which are incorporated herein by reference.

### BACKGROUND

The invention relates generally to an enhanced performance connector and in particular, to a connector including a plug and outlet designed for enhanced performance.

Improvements in telecommunications systems have resulted in the ability to transmit voice and/or data signals along transmission lines at increasingly higher frequencies. Several industry standards that specify multiple performance levels of twisted-pair cabling components have been established. The primary references, considered by many to be the international benchmarks for commercially based telecommunications components and installations, are standards ANSI/TIA/EIA-568-A (/568) Commercial Building Telecommunications Cabling Standard and ISO/IEC 11801 (/11801), generic cabling for customer premises. For example, Category 3, 4 and 5 cable and connecting hardware are specified in both /568 and /11801, as well as other national and regional specifications. In these specifications, transmission requirements for Category 3 components are specified up to 16 MHz. Transmission requirements for Category 4 components are specified up to 20 MHz. Transmission requirements for Category 5 components are specified up to 100 MHz. The above referenced transmission requirements also specify limits on near-end crosstalk (NEXT).

Often, telecommunications connectors are organized in sets of pairs, typically made up of a tip and ring connector. As telecommunications connectors are reduced in size, adjacent pairs are placed closer to each other creating crosstalk between adjacent pairs. To comply with the near-end crosstalk requirements, a variety of techniques are used in the art.

Compensation for the modular jacks and plugs has been added using external elements such as a PCB, flex circuits, discreet components (i.e. resistors, capacitors). These previous methods add cost and complexity. As the bandwidth requirements increase due to higher signaling rates, such as 10GBASE-T Ethernet and beyond, components need to be improved.

While there exist plugs and outlets designed to reduce crosstalk and enhance performance, it is understood in the art that improved plugs and outlets are needed to meet increasing transmission rates.

### SUMMARY

An embodiment of the invention is a telecommunications outlet including a contact carrier and a plurality of contacts supported on the contact carrier, the contacts corresponding to tip and ring pairs, at least one of the contacts having a characteristic to improve signal transmission performance by providing internal compensation to balance signals by controlling resistive, inductive or capacitive characteristics along the contacts.

### BRIEF DESCRIPTION OF THE DRAWINGS

FIG. 1 is a front view of an outlet in embodiments of the invention.

FIG. 2 is a perspective view of a contact carrier of FIG. 1.

FIG. 3 is a side view of the contact carrier of FIG. 2.

FIG. 4 is a front view of an outlet in alternate embodiments of the invention.

FIG. 5 is a perspective view of a contact carrier of FIG. 4.

FIG. 6 is a side view of the contact carrier of FIG. 5.

FIG. 7 is a front view of an outlet in alternate embodiments of the invention.

FIG. 8 is a bottom view of the outlet of FIG. 7.

FIG. 9 illustrates contacts within the outlet of FIG. 7.

FIG. 10 is a perspective view of an outlet in alternate embodiments of the invention.

FIG. 11 is a cross-sectional view of a plug mating with the outlet of FIG. 10.

FIG. 12 is a perspective view of the contact carrier of FIG. 10 on a circuit board.

FIG. 13 is a perspective view a contact carrier in alternate embodiments.

FIG. 14 is a perspective, partial cut-away view of a plug in embodiments of the invention.

FIG. 15 is a top view of the plug of FIG. 13.

### DETAILED DESCRIPTION

FIG. 1 is a front view of an outlet 100 in embodiments of the invention. As known in the art, the outlet includes eight contacts 102. It is understood that the number of contacts may vary depending on application, and embodiments of the invention are not limited to eight contacts. As is known in the art, contacts are referred to as being in eight positions 1-8, from one side of the outlet to the other. The contacts may be arranged in tip and ring pairs as is known in the art with, contacts 1/2, 3/6, 4/5 and 7/8 defining tip and ring pairs. Embodiments of the invention are described with reference to contacts in different positions.

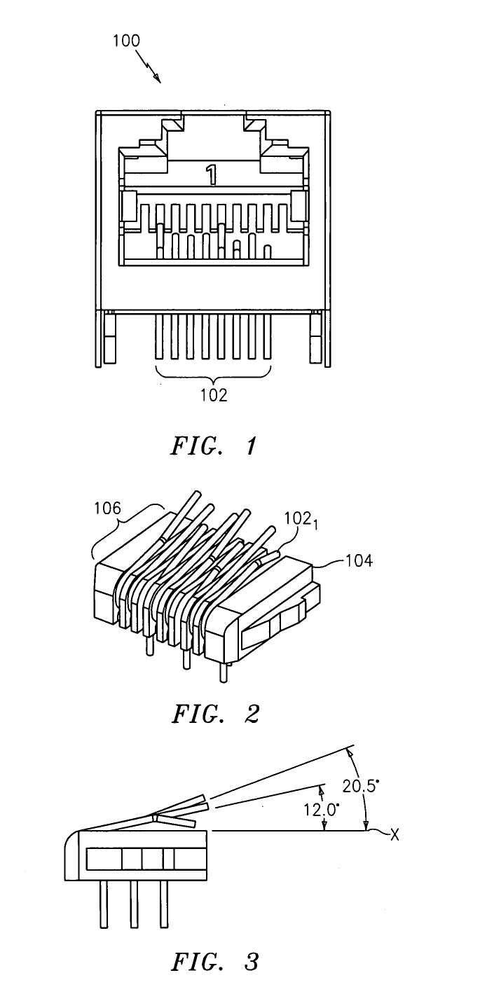

FIG. 2 is a perspective view of a contact carrier 104 of FIG. 1, depicting the first contact as 102₁. In this embodiment crosstalk is reduced by altering features of the contacts 102. One feature is the length of the contacts. In FIG. 2, contacts in positions 3 and 6 are shorter than the other contacts. Thus, contacts 3 and 6 do not extend as far in the mating region 106 above the top surface of contact carrier 104 where contacts from a plug make electrical contact with contacts 102. Another feature is the angle of the contact with respect to an axis X parallel to the top surface of the contact carrier. Contacts in positions 4, 6 and 8 are at a first angle (e.g., 20.5 degrees) with reference to axis X. Other contacts in positions 2, 5 and 7 are at a second angle (e.g., 12 degrees) with reference to axis X. Another feature is the inclusion of a bend in the contact, such that the angle of the contact with reference to axis X decreases at the bend. As shown in FIGS. 2 and 3, contact in position 1 has a bend towards axis X.

This arrangement of the contacts improves signal transmission performance by providing internal compensation to balance signals by adjusting the contacts to maximize resistive, inductive, capacitive characteristics (including signal phase delay) along contacts 102. For example, adjusting the length, adding bends, adjusting the spacing of the contacts is performed to compensate for crosstalk within the outlet. Further, the cross sectional size of the contacts, the cross sectional shape of the contacts and/or the conductivity of the material used in one or more of the contacts may be varied to alter resistive, inductive, capacitive characteristics (including signal phase delay) of contacts 102.

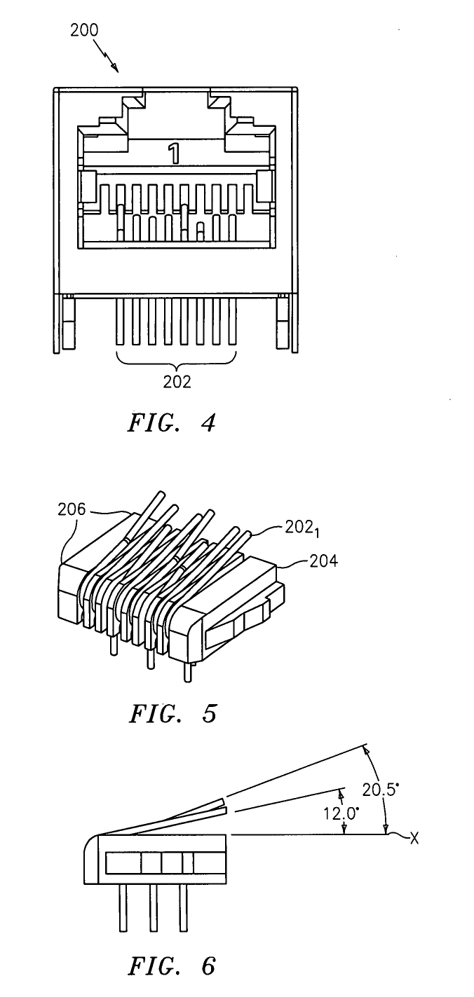

FIG. 4 is a front view of an outlet 200 in embodiments of the invention. As known in the art, the outlet includes eight contacts 202. It is understood that the number of contacts may vary depending on application, and embodiments of the invention are not limited to eight contacts. As is known in the art, contacts are referred to as being in eight positions 1-8, from one side of the outlet to the other. The contacts may be arranged in tip and ring pairs as is known in the art with, contacts 1/2, 3/6, 4/5 and 7/8 defining tip and ling pairs.

Embodiments of the invention are described with reference to contacts in different positions. FIG. 5 is a perspective view of a contact carrier 204 of FIG. 4, depicting the first contact as 202₁. In this embodiment crosstalk is reduced by altering features of the contacts 202. One feature is the length of the contacts. In FIG. 5, contacts in positions 3 and 6 are shorter than the other contacts. Thus, contacts 3 and 6 do not extend as far in the mating region 206 above the top surface of contact carrier 104 where contacts from a plug make electrical contact with contacts 102. Another feature is the angle of the contact with respect to an axis X parallel to the top surface of the contact carrier. As shown in FIG. 6, contacts in positions 4, 6 and 8 are at a first angle (e.g., 20.5 degrees) with reference to axis X. Other contacts in positions 1, 2, 3, 5 and 7 are at a second angle (e.g., 12 degrees) with reference to axis X.

This arrangement of the contacts improves signal transmission performance by providing internal compensation to balance signals by adjusting the contacts to maximize resistive, inductive, capacitive characteristics (including signal phase delay) along contacts 202. For example, adjusting the length, adding bends, adjusting the spacing of the contacts is performed to compensate for crosstalk within the outlet. Further, the cross sectional size of the contacts, the cross sectional shape of the contacts and/or the conductivity of the material used in one or more of the contacts may be varied to alter resistive, inductive, capacitive characteristics (including signal phase delay) of contacts 202.

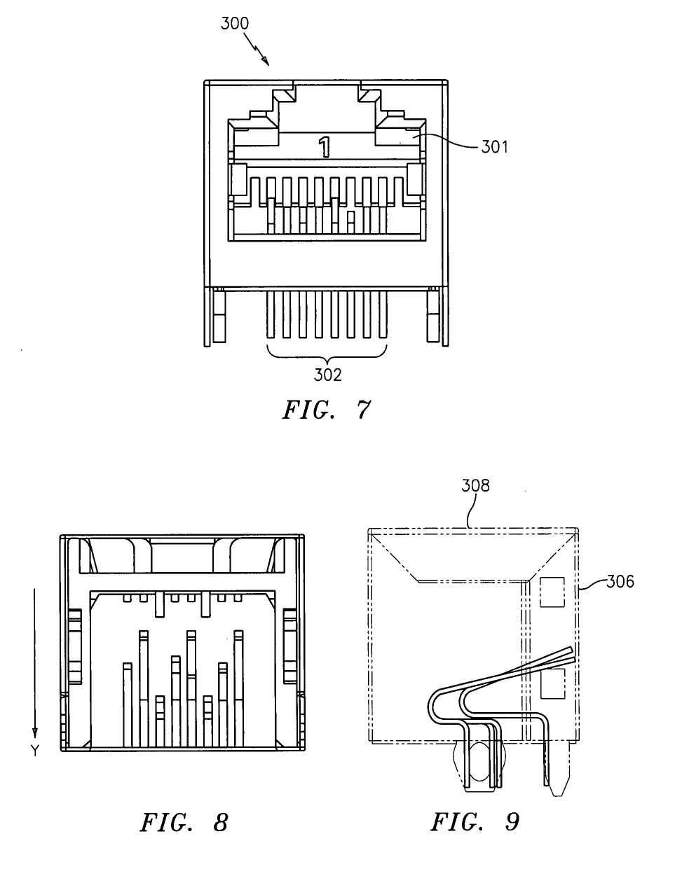

FIG. 7 is a front view of an outlet 300 in alternate embodiments of the invention. As known in the art, the outlet includes eight contacts 302. It is understood that the number of contacts may vary depending on application, and embodiments of the invention are not limited to eight contacts. As is known in the art, contacts are referred to as being in eight positions 1-8, from one side of the outlet to the other. The contacts may be arranged in tip and ring pairs as is known in the art with, contacts 1/2, 3/6, 4/5 and 7/8 defining tip and ring pairs. Embodiments of the invention are described with reference to contacts in different positions.

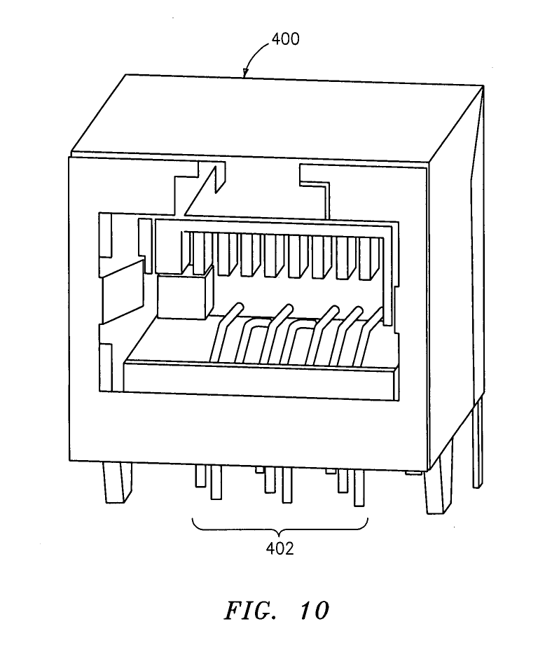

FIG. 8 is a bottom view of the outlet of FIG. 7. As shown in FIG. 8, contacts in positions 4 and 5 are moved to be closer together along axis Y than other adjacent contacts. The axis Y is parallel to the side of the outlet 300 and extends parallel to the 8 contacts 302. FIG. 9 illustrates contacts within the outlet of FIG. 7. As shown in FIG. 9, contacts 302 in positions 3 and 6 are moved back relative to the remaining contacts towards a rear wall 306 of outlet 300. Further, contacts 302 in positions 3 and 6 are moved upwards relative to the remaining contacts towards a top wall 308 of the outlet 300. The positioning of contacts 302 may be varied to alter resistive, inductive, capacitive characteristics (including signal phase delay) of contacts 302. Further, the cross sectional size of the contacts, the cross sectional shape of the contacts and/or the conductivity of the material used in the contacts may be varied to alter resistive, inductive, capacitive characteristics (including signal phase delay) of contacts 202.

FIG. 10 is a perspective view of an outlet 400 in embodiments of the invention. As known in the art, the outlet includes eight contacts 402. It is understood that the number of contacts may vary depending on application, and embodiments of the invention are not limited to eight contacts. As is known in the art, contacts are referred to as being in eight positions 1-8, from one side of the outlet to the other. The contacts may be arranged in tip and ring pairs as is known in the art with, contacts 1/2, 3/6, 4/5 and 7/8 defining tip and ring pairs.

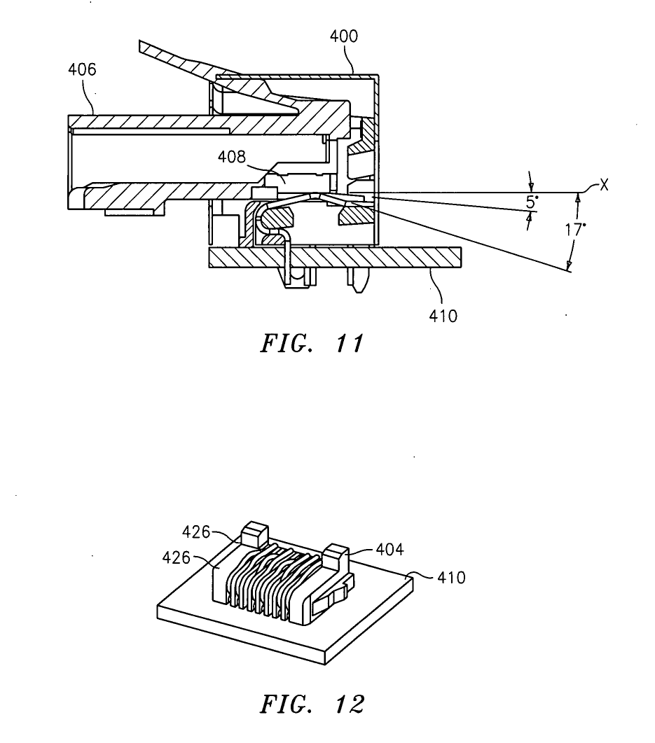

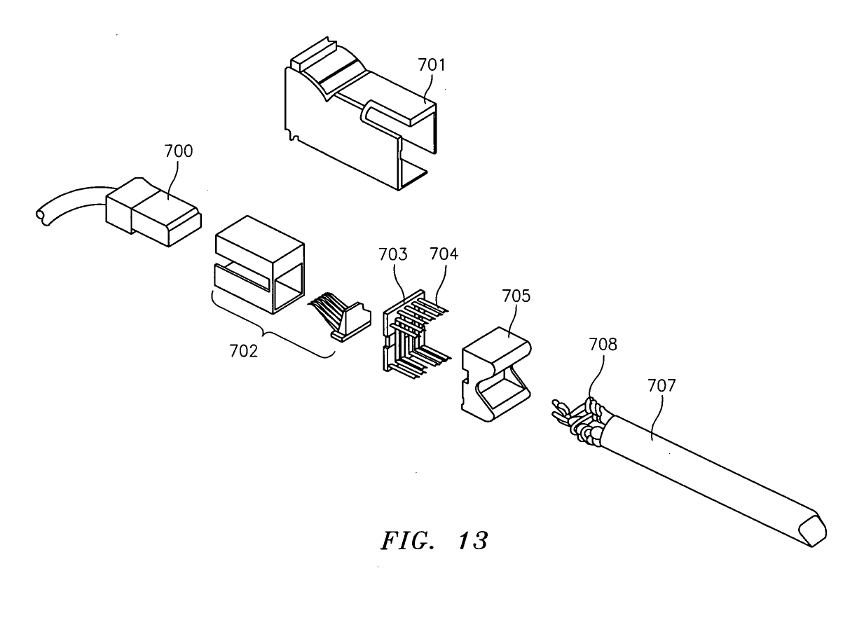

Embodiments of the invention are described with reference to contacts in different positions. As shown in FIG. 10, all contacts 402 have a bend that directs the contact towards axis X (FIG. 11). Contacts 402 in positions 4, 6 and 8 are have a higher angle with reference to axis X than contacts 402 in positions 1-3, 5 and 7 which have a smaller angle with reference to axis X. Axis X is parallel to the top surface of contact carrier 404. FIG. 11 is a cross-sectional view of a plug 406 mating with outlet 400. The bends in the contacts 402 permit the contacts 402 to maintain consistent physical and electrical contact with contacts 408 in plug 406 in mating region 426 above top surface of the contact carrier 404. The bends also provide a uniform displacement of the contacts 402 when plugs having different dimensions are mated with outlet 400. Accordingly, in the mated state, the contacts 402 are in predicted positions regardless of the size of the plug 406 or insertion depth of the plug 406 into outlet 400. This allows for control of crosstalk between contacts 402 as the location of the contacts in the mated state does not vary. FIG. 12 is a perspective view of the contact carrier 404 of FIG. 10 on a circuit board 410.

This arrangement of the contacts improves signal transmission performance by providing internal compensation to balance signals by adjusting the contacts to maximize resistive, inductive, capacitive characteristics (including signal phase delay) along contacts 402. For example, adjusting the length, adding bends, adjusting the spacing of the contacts is performed to compensate for crosstalk within the outlet. Further, the cross sectional size of the contacts, the cross sectional shape of the contacts and/or the conductivity of the material used in one or more of the contacts may be varied to alter resistive, inductive, capacitive characteristics (including signal phase delay) of contacts 402.

FIG. 13 is a perspective view of an exemplary termination of wires to an outlet in embodiments of the invention. FIG. 13 depicts an exemplary connector housing 701, patch cord 700 and twisted pair cable 707. Cable 707 includes four twisted pairs of wires 708. It is understood that embodiments of the invention may be used with cables having a different color code and the invention is not limited to cables having four twisted pairs of wires. The patch cord 700 includes a plug housing dimensioned to mate with existing modular outlets. The plug housing may be an RJ-45 type plug, but may have different configurations.

Connector 701 contains a substrate 703 which establishes an electrical connection between the jack assembly 702 and termination block 705. Wire termination connections 704 (e.g., insulation displacement contacts) are positioned in the termination block 105. The substrate 703 may be a printed circuit board, flexible circuit material, etc. having traces therein for establishing electrical connection between the jack assembly 702 contacts and termination block 705 termination connections 704. Termination block 705 may be a S310 block available from The Siemon Company. Substrate 703 may include compensation elements for tuning electrical performance of the plug 100 (e.g., NEXT, FEXT). In alternate embodiments, the jack assembly contacts 702 and IDC connections 704 are part of a lead frame, eliminating the need for substrate 703.

The jack assembly 702 includes a contact carrier with contacts 720. The contacts 720 may use one or more of the geometries described above with reference to FIGS. 1-12 to improve signal transmission performance by providing internal compensation to balance signals by adjusting the contacts to maximize resistive, inductive, capacitive characteristics (including signal phase delay) along contacts 720.

For example, adjusting the length, adding bends, adjusting the spacing of th-e contacts is performed to compensate for crosstalk within the outlet. Further, the cross sectional size of the contacts, the cross sectional shape of the contacts and/or the conductivity of the material used in one or more of the contacts may be varied to alter resistive, inductive, capacitive characteristics (including signal phase delay) of contacts 720. The contacts 720 extend from the rear wall of the contact carrier rather than the bottom (as shown in FIGS. 1-12), but still may include similar features to improve signal transmission performance.

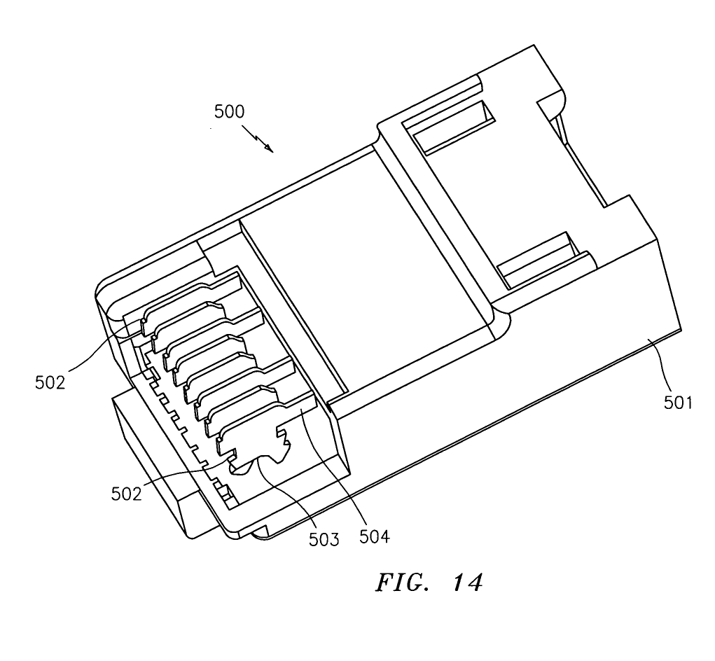

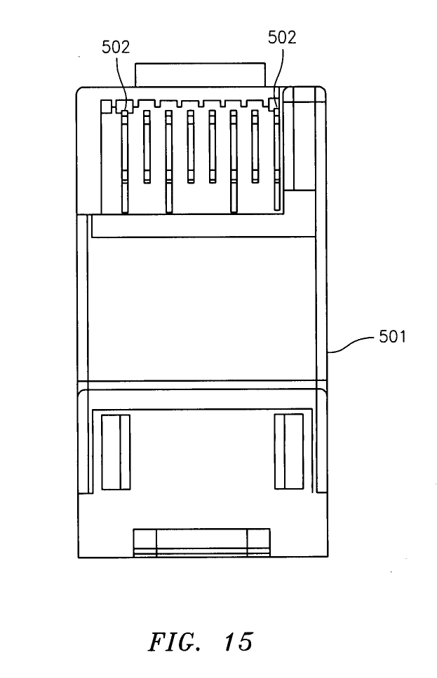

FIG. 14 is a perspective, partial cut-away view of a plug 500 in embodiments of the invention. Plug 500 includes a plug housing 501 and plug contacts 502 arranged in eight positions across the plug 500. Contacts 502 include an insulation displacement portion 503 for making electrical contact with individual wires as known in the art. The plug contacts 502 engage contacts in the outlets discussed above with reference to FIGS. 1-13. As shown in FIG. 14, the contacts 502 include extension 504. The extensions form increased surface area for the contacts and overlap in order to alter capacitive and/or inductive (e.g., reactive) interaction between contacts 502. In FIG. 14, contacts in positions 1, 3, 6 and 8 include extensions 504 to increase capacitive coupling between contacts 1 and 3 and contacts 6 and 8, respectively. It is understood that other contacts may include extensions and embodiments of the invention are not limited to FIG. 14. FIG. 15 is a top view of the plug of FIG. 14. In alternate embodiments, the contacts 502 include openings to alter capacitive and/or inductive (e.g., reactive) interaction between contacts 502. The openings may be formed uniformly across all contacts 502, or may be formed in a subset of contacts 502.

The embodiments of the invention discussed above improve the transmission performance (both signal and noise characteristics) of the RJ45 jack and/or plug by adding internal compensation within the components. The various wire forms adjust the magnitude and phase of the signals within the jack and this compensation improves overall signal integrity of the component.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A telecommunications outlet comprising:
a contact carrier;
a plurality of contacts supported on the contact carrier, the contacts corresponding to tip and ring pairs, at least one of the contacts having a characteristic to improves signal transmission performance by providing internal compensation to balance signals by controlling resistive, inductive or capacitive characteristics along the contacts.

2. The telecommunications outlet of claim 1 wherein:
two of the contacts are shorter than other contacts such that the two contacts extend for a shorter distance in a mating region above the contact carrier, the mating region being all area where the contacts make physical and electrical contact with plug contacts.

3. The telecommunications outlet of claim 2 wherein:
the contacts are arranged in 8 positions, the contacts in positions 3 and 6 being the two shorter contacts.

4. The telecommunications outlet of claim 1 wherein:
a first group of contacts have a first angle with reference to an axis parallel to the top surface of the contact carrier and a second group of contacts have a second angle with reference to the axis, the first angle and second angle being different.

5. The telecommunications outlet of claim 4 wherein:
at least one contact includes a bend such that the angle of the contact with reference to the axis decreases at the bend.

6. The telecommunications outlet of claim 1 further comprising:
a housing having an opening for receiving a plug;
wherein two of the contacts are positioned closer to each other than other contacts along an axis parallel to the opening.

7. The telecommunications outlet of claim 1 further comprising:
a substrate having traces in electrical connection with the contacts;
a termination block having wire termination connections in electrical connection with the traces.

8. A telecommunications plug comprising:
a plug body;
a plurality of plug contacts positioned in the plug body, the plug contacts having features for controlling reactive coupling between the contacts.

9. The telecommunications plug of claim 8 wherein:
the features on at least two plug contacts are extensions providing increased surface area for the two contacts and overlap to alter reactive interaction between contacts.

10. The telecommunications plug of claim 8 wherein:
the features on at least two plug contacts are openings formed in the two contacts to alter reactive interaction between contacts.
